(19) United States
(12) Patent Application Publication
(10) Pub. No.: US 2011/0293818 A1
(43) Pub. Date: Dec. 1, 2011

(54) Method and Apparatus for Depositing A Film Using A Rotating Source

(75) Inventors: Conor F. Madigan, San Francisco, CA (US); Hyeun-Su Kim, Palo Alto, CA (US); Dariusz Golda, Redwood City, CA (US); Valerie Gassend, San Carlos, CA (US); Manush Birang, Los Gatos, CA (US); Alexander Sou-Kang Ko, Santa Clara, CA (US); Eliyahu Vronsky, Los Altos, CA (US)

(73) Assignee: Kateeva Inc., Menlo Park, CA (US)

(21) Appl. No.: 12/954,910

(22) Filed: Nov. 29, 2010

Related U.S. Application Data
(60) Provisional application No. 61/283,011, filed on Nov. 27, 2009.

(51) Int. Cl. B05D 5/06; B05B 5/025; B05C 1/00; B05C 11/00; B05C 5/00; B05C 5/04

(52) U.S. Cl. 427/66; 118/300; 118/200; 118/264; 118/75; 118/620; 118/697

(57) ABSTRACT

The disclosure generally relates to a method and apparatus for depositing a substantially solid film onto a substrate. The solid film can be an Organic Light-Emitting Diode (“OLED”). In one embodiment, the disclosure relates to using a material supply, a rotating or moving mechanism having at least one transfer surface which is supplied with film material in one orientation and delivers film material to the substrate at a second orientation such that film material delivered to the substrate deposits in substantially solid form. The delivery to the substrate can be performed without the transfer surface materially contacting the substrate. The film material can be deposited on the transfer surface in either solid form or in liquid form (e.g., as a mixture of carrier liquid and dissolved or suspended film material).

The instant application claims priority to Provisional Application No. 61/283,011, filed Nov. 27, 2009, as well as application Ser. No. 12/139,404, filed Jun. 13, 2008, which claims priority to Provisional Application No. 60/944,000, filed Jun. 14, 2007. The disclosure of the above-identified applications are incorporated herein in their entirety.

### BACKGROUND

1. Field of the Invention

The disclosure generally relates to a method and apparatus for depositing a substantially solid film onto a substrate. More specifically, the disclosure relates to a novel method for printing an Organic Light-Emitting Diode (“OLED”) film using a rotating source.

2. Description of Related Art

In printing electronic films it is important to deposit a dry film onto a surface so that the material being deposited forms a substantially solid film upon contact with the substrate. This is in contrast with ink printing where wet ink is deposited onto the surface and the ink then dries to form a solid film. Because the inking process deposits a wet film, it is commonly referred to as a wet printing method.

Wet printing methods have two significant disadvantages. First, as ink dries, the solid content of the ink may not be deposited uniformly over the deposited area. That is, as the solvent evaporates, the film uniformity and thickness varies substantially. For applications requiring precise uniformity and film thickness, such variations in uniformity and thickness are not acceptable. Second, the wet ink may interact with the underlying substrate. The interaction is particularly problematic when the underlying substrate is pre-coated with a delicate film. An application, in which both of these problems are critical is the deposition of organic light-emitting diode (“OLED”) films.

The problem with wet printing can be partially resolved by using a dry transfer printing technique. In transfer printing techniques in general, the material to be deposited is first coated onto a transfer sheet and then the sheet is brought into contact with the surface onto which the material is to be transferred. This is the principle behind dye sublimation printing, in which dyes are sublimated from a ribbon in contact with the surface onto which the material will be transferred. This is also the principle behind carbon paper. However, the dry printing approach introduces new problems. Because contact is required between the transfer sheet and the target surface, if the target surface is delicate it may be damaged by contact. Furthermore, the transfer may be negatively impacted by the presence of small quantities of particles on either the transfer sheet or the target surface. Such particles will create a region of poor contact that impedes transfer.

The particle problem is especially acute in cases where the transfer region consists of a large area, as is typically employed in the processing of large area electronics such as flat panel televisions. In addition, conventional dry transfer techniques utilize only a portion of the material on the transfer medium, resulting in low material utilization and significant waste. Film material utilization is important when the film material is very expensive. An application where all of these problems are particularly pronounced is, again, the OLED film deposition.

Therefore, there is a need for a method and apparatus to provide, among others, a non-contact, dry technique for depositing an OLED film that overcomes these and other disadvantages and shortcomings.

### SUMMARY

In one embodiment, the disclosure relates to using a material supply, a rotating or moving mechanism having at least one transfer surface which is supplied with film material in one orientation and delivers film material to the substrate at a second orientation such that film material deposits on the substrate in substantially the solid phase.

In an embodiment, one or more transfer surfaces are combined with a rotating or moving mechanism such that the transfer surfaces rotate between first orientations in which they receive film material from the supply source and second orientations in which they deliver the film material onto the substrate. The rotating (or moving) mechanism can place the one or more transfer surfaces in other orientations while performing other process steps. Such process steps may include cleaning the transfer surface or conditioning the film material prior to transfer to the substrate. Such conditioning steps may include steps to remove carrier materials from an ink.

In another embodiment, a rotating mechanism is prepared with at least one transfer surface, at least a portion of this transfer surface having a micro-patterned structure, which may include micropores, micro-pillars, micro-channels, or other micro-patterned structures, and may further include arrays of such structures (interchangeably, micro-arrays). The film material may be vaporized to enable transfer from the transfer surface onto the substrate, for example by sublimation or by melting and subsequent vaporization. The vaporization may be thermally activated, in which case the activation mechanism includes thermal evaporation.

In still another embodiment, the disclosure relates to an apparatus for transferring film material onto a substrate without contact, the apparatus comprising: a transfer surface; a film material delivery mechanism for supplying a quantity of film material onto at least a portion of the transfer surface; wherein the transfer surface receives the quantity of film material from the film material delivery mechanism at a first plane and deposits at a second plane onto a substrate the quantity of film material, without material contact between the transfer surface substrate. Material contact, as used herein and without limiting the disclosure, means without direct contact (between the transfer surface and the substrate) or indirect contact (contact though a solid bridge or a liquid bridge formed by the material contained in the gap between the transfer surface and the substrate.) The film material may further deposit on the substrate in substantially the solid phase.

The film material may be further delivered to the transfer surface in the form a solid ink, liquid ink, or gaseous vapor ink. The film material may be delivered in the form a liquid ink comprising film material and a carrier fluid. The film material may be dry prior to transfer from the transfer surface onto the substrate.

In still another embodiment, the disclosure relates to a materially non-contact film-deposition apparatus, comprising: a film material delivery mechanism for supplying distinct quantities of a plurality of liquid inks, the liquid ink comprising a carrier fluid containing film materials; a transfer surface for receiving the distinct quantities of the plurality of liquid inks from the ink delivery mechanism; and a substrate. The substrate receives the film material contained within the liquid inks from the transfer surface without material contact and after each of the carrier fluids has been substantially evaporated from each of the distinct quantities of the plurality of liquid inks to thereby form a dry film material on the transfer surface.

In another embodiment, the disclosure relates to an apparatus for transferring film material onto a substrate without material contact and in a pre-defined pattern. The apparatus can comprise: a transfer surface, at least a portion of this transfer surface having a micro-patterned structure, which may include micropores, micro-pillars, or other micro-patterned structures; a film material delivery mechanism for supplying a quantity of film material onto at least a portion of the transfer surface, and an axis about which the transfer surface can receive the quantity of film material from the film material delivery mechanism and rotate prior to depositing the film material onto a substrate without material contact.

In yet another embodiment, the disclosure relates to a materially non-contact system for depositing a film on a substrate, the system comprising: a transfer surface; a film material delivery mechanism for supplying a quantity of film material onto at least a portion of the transfer surface; a memory circuit in communication with a controller circuit, the memory circuit containing instructions directing the controller circuit to: provide the quantity of film material onto the transfer surface in a prescribed pattern, positioning and aligning the transfer surface adjacent to but not in material contact with the substrate to transfer the quantity of film material onto the substrate, and positioning and aligning the transfer surface to receive an additional quantity of film material from the film material delivery mechanism.

In yet another embodiment, the disclosure relates to a method for depositing a film on a substrate such that the film material deposits in substantially the solid phase, the method comprising: providing a quantity of film material; supplying the quantity of film material to a transfer surface in a prescribed pattern; optionally conditioning the film material; rotating the transfer surface about an axis to position and align the transfer surface adjacent the substrate; and transferring the film material from the transfer surface to the substrate such that the film material deposits on the substrate in substantially the solid phase. The film material deposited onto the substrate can have a patterned shape or can be a uniform coating over the deposition area, and one of the ways this can be controlled is by the pattern used when supplying the quantity of film material onto the transfer surface. The film material can be delivered to the transfer surface in the form of a liquid ink containing film material and carrier fluid, and the carrier fluid can be substantially removed to form dry film material on the transfer surface prior to transferring film material to the substrate.

In another embodiment, the disclosure relates to a method for depositing a film onto a substrate such that the film material deposits in substantially solid phase by: providing a first quantity of film material and a second quantity of film material; supplying the first quantity of film material to a first transfer surface; optionally conditioning the first quantity of film material; supplying the second quantity of film material to a second transfer surface; and transferring the first quantity of film material from the first transfer surface to the substrate such that the film material deposits in substantially the solid phase; wherein the first transfer surface and the second transfer surface respectively define a first plane and a second plane. The film material can be delivered to the transfer surface in the form of a liquid ink containing film material and carrier fluid. The carrier fluid can be removed to form a substantially dry film material on the transfer surface prior to its transfer to the substrate.

In another embodiment, the disclosure relates to a method for printing an OLED film, the method comprising: providing a quantity of liquid ink to a transfer surface, the liquid ink defined by a carrier fluid containing dissolved or suspended film material; organizing the liquid ink into a prescribed pattern on the transfer surface with the assistance of a micro-patterned structure, which may contain micropores, micro-pillars, micro-channels, micro-arrays, or other micro-patterned structures; energizing the transfer surface to substantially evaporate the carrier fluid to form dry film material on the transfer surface; and transferring the film material from the transfer surface to the substrate such that the film material deposits in substantially the solid phase. The film material deposited onto the substrate can have a patterned shape or can be a uniform coating over the entire deposition area.

In still another embodiment, the disclosure relates to an apparatus for depositing a film material on a substrate without material contact such that the film material deposits in substantially the solid phase, the apparatus comprising: a transfer surface; a film material delivery mechanism for supplying a quantity of film material onto at least a portion of the transfer surface; a transfer surface activation mechanism for transferring film material on the transfer surface onto a substrate such that the film material deposits on the substrate in substantially the solid phase. The transfer surface receives the quantity of film material from the film material delivery mechanism at a first plane and transfers, at a second plane, onto a substrate the quantity of film material, without the transfer surface making material contact with the substrate.

In still another embodiment, the disclosure relates to a method for transferring film material onto a substrate without material contact such that the film material deposits in substantially the solid phase, the method comprising: providing a quantity of film material onto a transfer surface in a first plane; activating a transfer surface activation mechanism to transfer from the transfer surface onto a substrate the quantity of film material such that the film material deposits onto the substrate in substantially solid form. Multiple transfer surfaces may co-exist in the same plane, forming, for example, an array of smaller transfer surfaces mounted onto a base plate that can be configured as a unit onto a mechanism capable of moving the transfer planes through space from one plane to another. The moving mechanism can be, among others, a paddle (defined as a structure comprising a surface onto which the transfer surfaces can be attached at the end of an arm extending from an axis of rotation), a drum, a facetted drum or a conveyer belt.

The disclosure is not limited to delivering wet film material to a transfer surface. In another embodiment, dry film material is delivered to transfer surface for deposition onto the substrate. In the case that the film material is delivered to the transfer surface in liquid form, different ink delivery mechanisms can be utilized, including inkjet print head (or inkjet), slit or slot coating (with or without a doctor blade or air knife), wet stamping, gravure, and any other wet transfer mechanism. In the case that dry film material is delivered to the transfer surface, different material delivery mechanisms can be utilized. The dry material delivery may include vacuum thermal evaporation, sputtering, electron beam evaporation, chemical vapor deposition, other types of vapor deposition (for example, organic vapor phase deposition, dry stamping and any other solid material transfer mechanism.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically illustrates a rotating drum deposition system according to an embodiment of the disclosure;

FIG. 2 schematically illustrates a facetted deposition system according to another embodiment of the disclosure;

FIG. 3 is a schematic illustration of a rotating, facetted deposition system;

FIGS. 4A and 4B are exemplary flow diagrams showing the general steps implemented by controllers;

FIG. 5A shows an exemplary rotating drum component of a deposition system;

FIG. 5B is the planar representation of the outer surface of the rotating drum of FIG. 5A;

FIG. 5C is an exploded view of a region of the rotating drum surface of FIG. 5B;

FIG. 6A shows an exemplary rotating, facetted component of a deposition system;

FIG. 6B is surface representation of a transfer surface on one of the facets of the deposition system of FIG. 6A;

FIG. 6C is an exploded view of a micro-patterned region of transfer surface of FIG. 6B;

FIG. 7A shows an exemplary transfer surface unit having a heating unit and a micro-patterned region;

FIG. 7B shows an exemplary hexagonal rotating drum deposition system according to an embodiment of the disclosure;

FIG. 7C shows a detail view of the exemplary baseplate for mounting multiple transfer surface units in a substantially co-planar configuration of FIG. 7B;

FIGS. 8A-8D show exemplary micro-patterned surfaces according to one embodiment of the disclosure; and

FIGS. 9A-9C illustrate exemplary coating techniques for depositing film material on a transfer surface.

### DETAILED DESCRIPTION

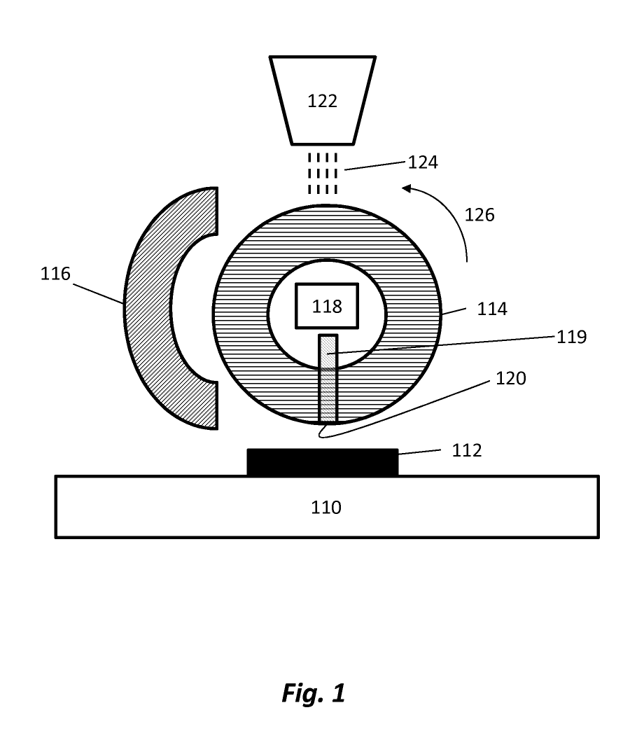

FIG. 1 schematically illustrates a rotating drum deposition system according to an embodiment of the disclosure. In FIG. 1, film material delivery mechanism 122 meters out film material. The metered out film material 124 can be metered as one or more droplets or as a stream.

The film material can be delivered to the transfer surface in the form of a solid ink, liquid ink, or gaseous vapor ink consisting of pure film material or film material and non-film (interchangeably, carrier) material. Using ink can be helpful because it can provide the film material to the transfer surface with one or more non-film materials to facilitate handling of the film material prior to deposition onto the substrate. The film material can consist of OLED material. The film material can comprise a mixture of multiple materials. The carrier material can also comprise of a mixture of multiple materials.

An example of a liquid ink is film material dissolved or suspended in a carrier fluid. Another example of a liquid ink is pure film material in the liquid phase, such as film material that is liquid at the ambient system temperature or film material that is maintained at an elevated temperature so that the film material forms a liquid melt. An example of a solid ink is solid particles of film material. Another example of a solid ink is film material dispersed in a carrier solid. An example of a gas vapor ink is vaporized film material. Another example of a gaseous vapor ink is vaporized film material dispersed in a carrier gas. The ink can deposit on the transfer surface as a liquid or a solid, and such phase can be the same or different than the phase of the ink during delivery. In one example, the film material can be delivered as gaseous vapor ink and deposit on the transfer surface in the solid phase. In another example, the film material can be delivered as a liquid ink and deposit on the transfer surface in the liquid phase. The ink can deposit on the transfer surface in such a way that only the film material deposits and the carrier material does not deposit; the ink can also deposit in such a way that the film material as well as one or more of the carrier materials deposits.

In one example, the film material can be delivered as a gaseous vapor ink comprising both vaporized film material and a carrier gas, and only the film material deposits on the transfer surface. In another example, the film material can be delivered as a liquid ink comprising film material and a carrier fluid, and both the film material and the carrier fluid deposit on the transfer surface. The film material delivery mechanism can further deliver the film material onto the transfer surface in a prescribed pattern. The delivery of film material to the substrate can be performed with material contact or without material contact between the transfer surface and the substrate.

Referring once again to FIG. 1, the metered film material 124 is directed to rotating drum 114. The film material can be directed to rotating drum 114 through gravity feed. Alternatively, a directed film material delivery system can be to target the metered film material 124 onto a specified portion of rotating drum 114. In one example, the film material delivery mechanism 122 is an inkjet printhead delivering droplets of liquid ink 124 onto the drum 114.

In the embodiment of FIG. 1, rotating drum 114 has a curved surface which defines one or more transfer surfaces. The transfer surface can function to receive in a first orientation the metered film material 124 and then transfer it in a second orientation onto a deposition surface. The metered film material 124 received on the surface of rotating drum 114 in the first orientation is moved towards substrate 110 and into the second configuration by the rotation of the drum as shown by arrow 126. Rotating drum 114 may have a single transfer surface defining a continuous belt-type surface at the periphery of drum 114 or it can define a number of discrete, independent or discontiguous surfaces.

Film material 124 may be delivered onto the transfer surface in a first prescribed pattern. In either the first, second, or other intermediate orientations (or planes), film material 124 may be organized on the transfer surface into a second prescribed pattern. In the second orientation (or, second plane), the film material 124 is transferred onto the substrate, and the film material may deposit on the substrate in a third prescribed pattern. The second and third prescribed patterns can be substantially the same, or they can be substantially different. The first and third prescribed patterns can be substantially the same, or they can be substantially different. The first and second prescribed patterns can be substantially the same, or they can be substantially different. The third pattern can comprise a blanket coating over the deposition area. The third pattern can comprise a microscale pattern of features over the deposition area. The third pattern can comprise a blanket coating over the deposition area. The first prescribed pattern may comprise an approximate, inaccurate or imprecise version of the second prescribed pattern. The first prescribed pattern may comprise a blanket coating over the transfer surface. The first prescribed patterned may be substantially the same as the second prescribed pattern. The third prescribed pattern may comprise a broadened, rounded, and/or smoothed version of the second prescribed pattern.

Each transfer surface can further contain micro-pattered features, such as micropores, micro-channels, micro-pillars, or other micro- or nano-patterned structures, and may further include arrays of such structures (interchangeably, micro-arrays). The micro-patterned structure can organize the film material by holding a pattern as delivered by the delivery mechanism. It can also organize the film material by rearranging the film material into a new pattern. Thus, micro-patterning can be used to organize the film material by both holding a pattern and/or changing the pattern of material in order to achieve a desired pattern. The micro-patterning can assist in organizing the metered film material 124 once received on the transfer surface. Such organization may be carried out by means of capillary or other forces acting between the micro-patterned structure and the material deposited on the transfer surface. In the case the transfer surface has a micro-patterned structure, such micro-patterned structure may assist in the organization of film material 124 on the transfer surface, and following such organization film material 124 may be substantially on regions with micro-patterned structures, substantially on regions without the micro-patterned structures, or substantially on both such regions.

The micro-patterned structure can be utilized in a coordinated fashion with a pattern of film material delivery to achieve a desired pattern of film material on the transfer surface prior to transfer to the substrate so as to assist the deposition of a desired pattern of film material on the substrate. In one example of coordinated delivery of film material in a pattern and utilization of a micro-patterned structure, the film material can be delivered onto the transfer surface such that it forms solid deposit in one pattern with respect to the micro-patterned structure and then melted such that the film material flows into a second pattern with assistance from the micro-patterned structure. In another example of coordinated delivery of film material in a pattern and utilization of a micro-patterned structure, the film material can be delivered onto the transfer surface as a liquid ink containing film material and a carrier fluid in one pattern with respect to the micro-patterned structure such that the liquid ink then flows into a second pattern with assistance from the micro-patterned structure. Following the delivery of film material 124 onto drum 114, the film material may be conditioned to prepare it for transfer onto substrate 110. The conditioning step may include steps to remove carrier materials from an ink, in the case that film material 124 is delivered onto the transfer surface in the form of an ink comprising film material and carrier material. In another example, film material 124 is delivered to the transfer surface in the form of a liquid ink containing film material and carrier liquid, and such conditioning steps may include heating or introducing a purging gas to substantially remove the liquid carrier fluid so that the film material 124 on the transfer surface is substantially free of carrier fluid (interchangeably, dry). Dry film material can comprises film material containing carrier fluid concentrations ranging from a simple minority (i.e., less than 50% by weight) to less than 1% or even trace levels. In another example, such conditioning steps may include heating the film material 124 (or an ink containing the film material 124) to melt the film material 124 (or at least a portion of the ink containing the film material 124) so as to alter the film material (or ink) composition, microstructure, or pattern on the transfer surface. In another example, the film material 124 is delivered in the form of a liquid ink comprising film material and a carrier fluid, the carrier fluid is removed from the ink to form dry, substantially solid film material 124, and such conditioning steps may then further include heating and thereby melting the film material 124 so as to alter the film material composition, microstructure, or pattern on the transfer surface. In one embodiment, solid film material comprises at least 50% by weight of material in solid phase. This includes film material which comprise a combination of solid phase material and gaseous phase material, or a combination of solid and liquid phase material.

Such conditioning may occur at the first orientation, the second orientation, at an intermediate orientation, or at a combination of these orientations. Such conditioning may even occur wholly or in part while the system transitions from one orientation to another. In addition, such conditioning may or may not involve one or more additional conditioning apparatuses (interchangeably, conditioning units). In one example, a liquid ink comprising film material and a carrier fluid may be dried passively by providing sufficient time for natural carrier fluid evaporation. The conditioning need not require an explicit third orientation (as it may, for example, occur during the transition between the first and second orientations) or any additional conditioning apparatus. In another example, a similar liquid ink may be actively dried, for example, by heating the transfer surface and/or by purging the region around the transfer surface with a gas. The heating and/or purging can be effected through the use of a conditioning apparatus capable of externally supplying a heat and/or gas source. The heating and/or purging can also be effected at an explicit third orientation. The external heat conditioning can be effected by activating an external radiation source and directing that radiation onto the transfer printhead so as to heat the transfer surface. Alternatively, such heat conditioning can also be effected by utilizing a conditioning unit integrated into the transfer surface itself, such as an integrated heater, in which case no external conditioning apparatus is required. The conditioning units (either external or integrated into the transfer surface) may also serve other, non-conditioning, functions within the deposition system.

Optional conditioning unit 116 is positioned near the outer surface of rotating drum 114. The conditioning unit may also be positioned inside the drum. Conditioning unit 116 can transmit radiation, convection or conduction heating or introduce directed gas flows to condition the metered film material prior to transferring the film material from the transfer surface to substrate 110. In one embodiment, the metered film material 124 comprises a quantity of liquid ink comprising film material and a carrier fluid and conditioning unit 116 functions as a drying unit to substantially evaporate the carrier fluid to form a substantially dry layer of film material on the transfer surface of rotating drum 114.

Following rotation of drum 114 to the second orientation, film material 124 is transferred from the transfer surface onto substrate 110. The film material transfer process may occur without material contact between the transfer surface and the substrate. A non-contact transfer is desirable for providing for high quality, accurate and precise film formation without sensitivity to particles, which can impede film transfer when used in a contact transfer process. Other advantages of a non-contact transfer process include greater repeatability, higher material utilization and less damage to either the transfer surface or the deposition surface. In a non-contact example, the film material may be vaporized to enable transfer from the transfer surface onto the substrate without material contact, for example by sublimation or by melting and subsequent vaporization. Such vaporization may be thermally activated, in which case the activation mechanism consists of thermal evaporation. In another non-contact example, the film material may be transferred by mechanically agitating the transfer surface such that the film material is dislodged and once dislodged transfers onto the substrate. Such mechanical agitation can be utilized to dislodge both solid and liquid phase materials from the transfer surface, and can be effected utilizing piezoelectric elements on or otherwise attached to the transfer surface. The film material transfer process may also occur with material contact between the transfer surface and the substrate. In one such embodiment, the transfer surface may be pressed onto the substrate and transfer effected through the application of pressure such that the film material releases from the transfer surface and transfers onto the substrate. The film material may be deposited onto the substrate in substantially solid phase. In an example of a solid phase deposition, the transfer surface vaporizes the film material and the film material vapor condenses on a substrate having a temperature less than the melting temperature of the film material such that the film material vapor condenses to form substantially solid material. The film material may alternatively be deposited onto the substrate in substantially the liquid phase. In one example of such liquid phase deposition, the transfer surface vaporizes the film material and the film material vapor transfers onto a substrate having a temperature higher than the melting temperature of the film material such that the material condenses onto the substrate as a substantially liquid melt.

The film material may be deposited on the substrate in the liquid phase. For example, the film material on the transfer surface may be in the liquid phase at the time of transfer, and the liquid film material be released from the transfer surface by agitation, causing the liquid phase material to transfer directly but without material contact between the transfer surface and the substrate. In yet another example of liquid phase deposition, the film material on the transfer surface may be in the liquid phase at the time of transfer, and the liquid film material brought into physical contact with the substrate such that the liquid then releases from the transfer surface and deposits onto the substrate. In the case that the film material deposits in the liquid phase, the deposited film material can then undergo a phase transition following deposition into a solid phase, either through passive or active treatment of the deposited film material. For example, if the film material is deposited as a melt and the substrate is then cooled, the deposited film material melt can solidify and form a solid phase deposit.

Optical source 118 and optical pathway 119 are configured to energize region 120 on the transfer surface. Region 120 contains the film material 124, the transfer surface having previously received the film material 124 in the first configuration and now rotated into the second configuration. By energizing the transfer surface, transfer of the film material from the transfer surface and onto the substrate is carried out. Optical light source 118 can be a laser source in communication with an optical train (lenses, filters, etc.) allowing the energy to be focused on one or more discrete regions of rotating drum 114. Optical light source 118 can energize region 120 of the transfer surface thermally or through radiation heating. The application of optical light source 118 is optional and other means for energizing the transfer surface to effect the transfer of the film material onto the deposition surface are well within the scope of the disclosure. In one embodiment, the transfer surface contains an integrated heater (not shown), such as a resistive heater, and the activation of this heater effects transfer of the film material onto the substrate, for example by thermally evaporating the film material. In another embodiment, the transfer surface contains an integrated piezoelectric material (not shown) that can be activated to assist the transfer of the film material onto the deposition surface, for example by agitating and thereby dislodging the film material from the transfer surface. In yet another embodiment, an external mechanism is provided to direct vibration or pressure waves onto the transfer surface to assist the transfer of the film material onto the deposition surface, for example by agitating and thereby dislodging the film material from the transfer surface.

As the film material is transferred from rotating drum 114, it deposits onto substrate 110 to form layer (interchangeably, film) 112. In one exemplary embodiment the film material 124 is delivered to the transfer surface in the form of a liquid ink comprising film material and a carrier fluid and the corresponding deposited layer 112 is substantially free of the carrier fluid (interchangeably, dry) which was part of the liquid ink.

Some of the film material delivered onto the transfer surface may not be deposited onto the substrate. Some of the film material can remain on the transfer surface following activation to transfer the film material. Such material may contaminate the transfer surface and require periodic removal from the transfer surface via a cleaning operation. Some of the film material can transfer off the transfer surface but not deposit on the substrate. In one example, such lost film material may be generated when the transfer surface utilizes thermal evaporation to transfer the film material onto the substrate if some of the vaporized film material does not stick to the substrate and instead travels towards and condenses onto another surface. The lost film material may be generated prior to the transfer of the film material onto the substrate during a conditioning step. For example, film material can be removed from the transfer surface while removing carrier fluid from a liquid ink. As a result, the deposition apparatuses and deposition methods described herein are envisions such that they may deposit onto the substrate all or only a portion of the film material delivered onto the transfer surface.

The drum can rotate either continuously or in a start-stop mode. In a continuous mode, the inking, film deposition and other orientations can comprise continuous orientations. In a start-stop mode, the inking, film deposition and other orientations comprise discrete orientations.

It should be noted that rotating drum 114 is a non-limiting exemplary embodiment of the disclosure and the implementation of the disclosed principles can be accommodated with a transfer surface that does not comprise wholly or in part the outer surface of a drum. For example, the transfer surface may comprise the outer surface of an object having an ovoid or spherical cross-section, or the outer surface of an object having discrete, substantially planar facets.

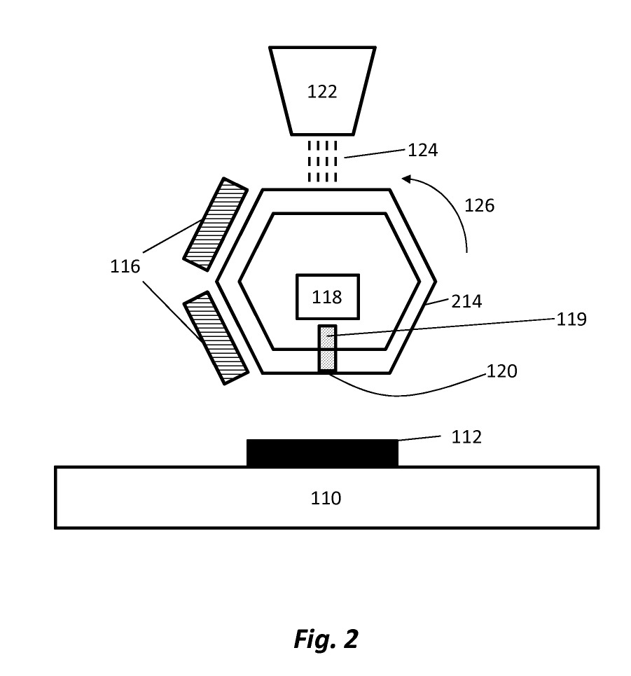

FIG. 2 schematically illustrates a deposition system according to another embodiment of the disclosure. In FIG. 2, a hexagonal conveyor-type (interchangeably, facetted drum) deposition system 214 is used to deposit film material on a substrate. All other peripheral parts are similar to those of FIG. 1 and are similarly numbered. Deposition system 214 of FIG. 2 has six separate and independent facets, at least a portion of each of the facet surfaces containing transfer surfaces. Each transfer surface can receive film material from material delivery mechanism 122 in one orientation and deliver the received film material to substrate 110 in another orientation.

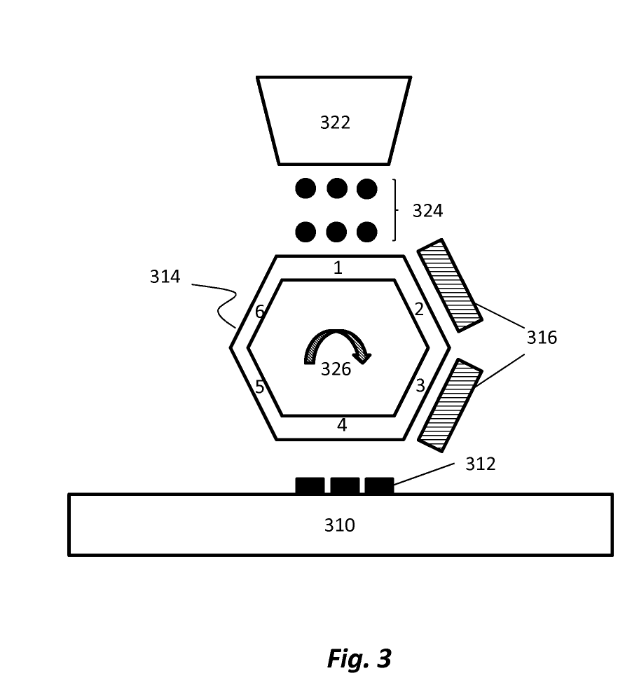

FIG. 3 is another schematic illustration of a rotating, facetted, deposition system. In FIG. 3, facetted drum 314 has six discrete surfaces which are numbered as surfaces 1 through 6. Each surface can contain a single transfer surface or a plurality of independent and discontinuous transfer surfaces. In one exemplary embodiment, each facet contains a baseplate that further contains multiple independent and discontiguous transfer surfaces, the baseplate providing a means for: (1) mounting one or more discrete transfer surfaces onto the baseplate in substantially the same plane, and (2) mounting the combination of one or more transfer surfaces onto a facet as a single unit. Each transfer surface may contain one or more micro-patterned regions arranged to organize the film material on the transfer surface in a prescribed pattern to form a particular pattern of deposited film material on the deposition surface. The transfer surfaces receive metered film material 324, which can comprise a liquid ink containing dissolved or suspended film material in a carrier fluid.

The rotation direction of facetted drum 314 is shown by arrow 326. Film material delivery mechanism 322 meters film material 324 to the one or more transfer surfaces located on facet 1 of the facetted drum 314. In one embodiment, film material delivery mechanism 322 comprises an inkjet printhead for metering film material in the form of a liquid ink. As facetted drum 314 rotates along the direction of arrow 326, one or more transfer surfaces on facet 1 pass by optional conditioning units 316. Optional conditioning units 316 may comprises heaters, and in an embodiment where the metered film material comprises a liquid ink, heaters 316 can assist in evaporating the carrier fluid from the one or more transfer surfaces on facet 1, such that the film material forms a dry deposit on the transfer surface. In general, the one or more transfer surfaces may have a micro-patterned structures for organizing the film material on the transfer surface.

As facet 1 reaches substrate 310, the film material on the one or more transfer surfaces on facet 1 will be dry. The dry film material is then transferred from the one or more transfer surfaces on facet 1 to substrate 310 without material contact between the one or more transfer surfaces on facet 1 and substrate 310.

The transfer of film material from a facet to the substrate can be gravity fed or it can be supplemented with an external energy source. For example, the one or more transfer surfaces on facet 1 can be equipped with piezoelectric actuators that can dislodge the film material from the transfer surface and transfer the film material onto the deposition surface. The transfer surfaces on facet 1 can alternatively be equipped with thermal actuators that can deliver thermal energy to the film material and thereby transfer the film material onto the deposition surface, for example, by thermally evaporating or vaporizing the film material. The system of FIG. 3 can also be equipped with an optical device (such as those discussed in relation to FIG. 1) to assist in transferring the film material from the transfer surface to the deposition surface.

The film material deposits on substrate 310 in substantially solid phase to form film 312. The shape (and topography) of film 312 is determined in part by the location and arrangement of the film material on the transfer surface prior to transfer to the substrate, which is determined by the spatial pattern utilized by the film delivery mechanism when metering out film material onto the transfer surface. The arrangement of the film material on the transfer surface can be further determined in part by the presence of a micro-patterned structure (not shown) on the transfer surface. In FIG. 3, film material is arranged on the one or more transfer surfaces on facet 1 so as to provide three discrete and discontiguous regions of deposited film material on the substrate. Thus, film 312 reflects these three discrete and discontiguous regions.

The system of FIG. 3 may also include a controller for monitoring and controlling the deposition process. The controller can include a processor circuit in communication with a memory circuit, the film delivery mechanism and one or more actuators. The processor circuit can comprise one or more microprocessors. The memory circuit contains instructions which are communicated to the controller circuit and the actuator to, for example, (i) position one or more transfer surfaces on a first facet adjacent or proximal to the film material delivery mechanism; (ii) meter a quantity of film material onto the one or more transfer surfaces on a first facet; (ii) heat the transfer surface(s) on a first facet to condition the film material, for example, to substantially evaporate the carrier fluid if the metered film material is liquid ink; (iii) position the transfer surfaces proximal to the substrate to transfer the film material from the transfer surface onto the substrate; (iv) heat the transfer surface(s) on a first facet to transfer the film material onto the substrate, for example, by thermally evaporating or vaporizing the film material; and (v) repeat the process with one or more transfer surfaces on a second facet.

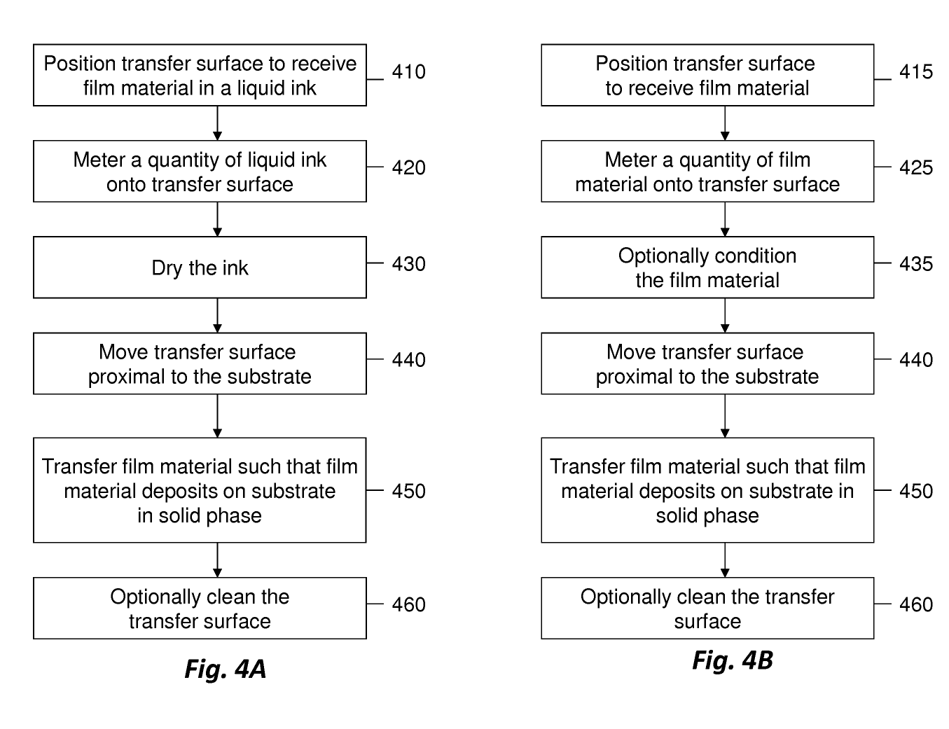

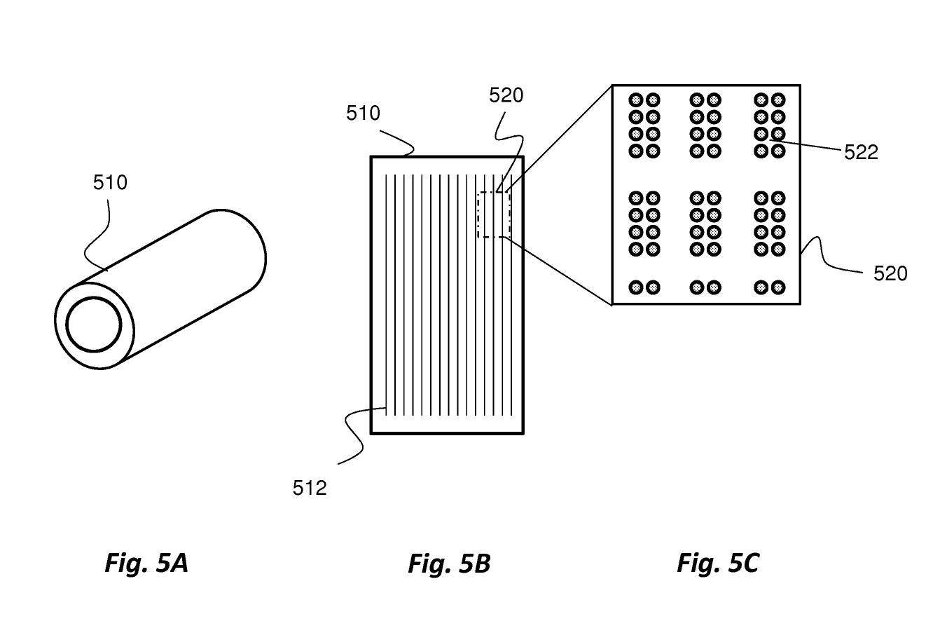

FIGS. 4A and 4B are exemplary flow diagrams showing the general steps implemented by exemplary controllers. Referring to FIG. 4A, in step 410 the controller positions a transfer surface to receive film material. As stated, the film material can have any physical phase. In the exemplary embodiment of FIG. 4A, the film material is liquid ink. In step 420, the controller causes a quantity of liquid ink to be metered onto the regions of a transfer surface. This quantity can be consistent from one transfer surface to the next. Alternatively, the processor can cause different amounts of ink to be metered onto different or subsequent regions of the transfer surface. In an embodiment where the transfer surface comprises a number of facets with each facet having one or more micro-patterned surfaces (see FIG. 5), the controller can coordinate metering of a substantially identical (or different) amounts of ink material to each surface.

In step 430, the ink is optionally conditioned to form a substantially dry film material. The dry film material can reside on the transfer surface and may further comprise a film material that is substantially solid. It is noted that such steps may be optional, particularly in the case that the ink may dry and/or form a solid without any additional conditioning steps. In step 440, the transfer surface is moved to be near or proximal to the substrate. It should be noted that the steps of FIGS. 4A and 4B need not be implemented sequentially and can be implemented simultaneously. For example, steps 430 and 440 can be performed simultaneously. In step 450, the film material is transferred onto the substrate from the transfer surface. This step can be assisted by an activating energy source, including optical, thermal, electrical, mechanical or a combination thereof. The energy source can be external to the transfer surface or it can be integrated into or onto the transfer surface. Due to the conditioning of step 430, the film material is free of liquid and in substantially dry/solid state.

In one embodiment, the transfer from the transfer surface onto the substrate occurs by thermal evaporation. That is, the material is evaporated from the surface of the transfer surface and the vapors form a substantially solid film on the substrate. The optional step 460 can be implemented to prepare and condition the transfer surface to receive another quantity of metered film material, for instance, to clean the transfer surface. Such conditioning can be accomplished by, among others, by heating the transfer surface, vacuuming the transfer surface or washing the transfer surface. Referring to FIGS. 3 and 4, an exemplary cleaning step can be implemented on the transfer surfaces contained on facets 5 and 6, while the transfer surface on facet 4 is transferring film material onto the substrate. The conditioning step may also include using electro-mechanical and/or chemical techniques to remove residual materials from the transfer surfaces.

In step 415 of FIG. 4B, a transfer surface is placed proximal to the film delivery mechanism to receive the film material. The transfer surface may contain a micro-pattered surface for receiving and organizing the film material on the transfer surface. In step 425, a desired quantity of film material is metered onto the transfer surface. The film material can be provided in the form of a liquid ink from an inkjet head, slit or slot coater, wet stamp, or any other liquid ink delivery mechanism capable of metering a desired quantity in the designated pattern. If an inkjet head is used for film delivery mechanism, the inkjet print head can be configured with one or more actuators (e.g., piezoelectric elements or thermal elements) to enable metering the quantity of film material. The film material may also be provided in the form of a gas vapor defined by gas phase film material and an optional mixture of one or more carrier gases from a thermal evaporation, sputtering, electron beam evaporation or any other gas vapor delivery mechanism capable of metering the desired amount in the desired pattern.

In optional step 435, the transfer surface is heated or otherwise activated in order to condition the film material. When the metered film material comprises a liquid ink, heating or other activation can evaporate the carrier fluid to form a substantially dry deposit of film material on the transfer surface. The activation, whether thermal or otherwise, can be calculated to remove all or part of the carrier fluid. In an embodiment, the carrier fluid is substantially removed prior to transferring the film material from the transfer surface onto the substrate. In one example, immediately before transferring the film material from the transfer surface onto the substrate, the film material deposited on the transfer surface may contain 40 wt. % carrier fluid. In another example, immediately before transferring the film material from the transfer surface onto the substrate, the film material deposited on the transfer surface may contain less than 1 wt. % carrier fluid. When the transfer surface has a micro-patterned surface, the micro-patterned surface can assist in the re-organization of the film material into a prescribed pattern during such conditioning. Step 440-460 of FIG. 4B are similar to those described in relation with FIG. 4A and, for brevity, will not be repeated here.

It should be noted that while the exemplary embodiment of FIGS. 1-4 relate to materially non-contact printing (i.e., neither the transfer surfaces nor the underlying support surfaces contact the substrate, either through direct physical contact or through a mediating liquid or solid bridge of metered film material), the principles of the invention are not limited to materially non-contact printing. Indeed, in some exemplary embodiments the deposition surfaces can materially contact the substrate without departing from the disclosed principles.

FIG. 5A shows an exemplary rotating drum component of a deposition system according to an embodiment of the disclosure. Rotating drum 510 has an inner surface and an outer surface as shown. The rotating drum can be made from metal, alloys, polymers, semiconductors, or any other suitable material which can be prepared to function as a transfer surface, which can include a micro-patterned surface structure. The outer surface of the rotating drum can be configured to have one or more transfer surfaces. The transfer surface(s) can form a continuous band around the drum or can define discrete and discontiguous regions on the drum. The transfer surfaces can have one or more micro-patterned regions thereon. The micro-patterned surface structure can include micropores, micro-channels, micro-pillars or any other micro-patterned structures. The micro-patterned regions may form a particular configuration designed to assist in organizing film material delivered onto the transfer surface into a prescribed or desired pattern. The size and length of the drum can be adjusted to accommodate printing substrates of varying sizes. The rotating drum can also be configured to be removed from the mechanism allowing its rotation and movement.

For a drum having a curved surface, the transfer surface can be comprised of a substantially rigid material having a curve matching the curvature of the drum surface or can be a flexible material that can be shaped to the drum surface. Examples of such material include plates of thin silicon or glass. For a drum having a facetted surface, the transfer surfaces can comprise substantially flat plates which are attached to corresponding flat regions on the facets of the supporting frame of the drum.

The system can further comprise one or more baseplates similar to those introduced with respect to FIG. 3 above. Such baseplates can provide a means for mounting one or more discrete transfer surfaces onto the baseplate and then mounting the combination of transfer surfaces onto a moving mechanism as a single unit, such moving mechanism comprising, for example, a drum or faceted drum. In the case that the baseplate attaches to the facet of a faceted drum, the baseplates can further mount the one or more transfer surfaces in substantially the same plane. The baseplates can have a variety of structures. In one embodiment, the transfer surface is integrated directly onto the baseplate. In another embodiment, each transfer surface comprises a discrete unit that is mounted independently onto the baseplate. The discrete transfer surface units can each comprise a transfer surface chip made from metal, alloys, polymers, semiconductors or any other suitable materials which can be prepared to function as a transfer surface and a package for removably interfacing such chip thermally, electrically and mechanically to the baseplate.

The transfer surface may comprise a discrete unit with a multilayer structure. For example, the transfer surface may have a three-layer structure, having an outside surface of thin silicon, onto which an optional micro-patterned surface may be formed, a buried oxide layer and layer(s) of thick silicon (called a “handle”). In this embodiment, the micro-patterned surface may include micro-pores, micro-channels, micro-pillars or other micro-patterned structures that extend through the thin silicon to the buried oxide layer. The thick silicon may have a patterned structure defining regions where the thin silicon and buried oxide layer form a membrane suspended between thick silicon supports. Such suspended membranes may be in the micro-patterned regions, where the thick silicon supports may be configured to be between the micro-patterned regions. The transfer surface unit may also be arranged such that only a portion of the unit is configured for receiving and transferring film material, and another portion of the unit is for supporting the transfer portion, and these two portions are connected through supporting beams. The transfer surface unit may alternatively comprise substantially the same structure as above without a buried oxide layer, and thereby comprise a single layer of silicon that otherwise contains substantially the same features of the transfer surface unit with the buried oxide layer.

The transfer surface unit may also comprise a two-layer structure having an outside surface of thin silicon, onto which an optional micro-patterned surfaced may be formed and a glass layer (e.g., Pyrex). The glass layer may have a patterned structure defining regions where the thin silicon forms a membrane suspended between glass supports.

The transfer surface units can in general be attached to a rotating or conveyor deposition system (e.g., drum or facetted drum or conveyor belt, according to other exemplary embodiments disclosed here) or baseplate thereon, and optionally through an additional intermediate package. The transfer surface units can also be attached to heat sinks that are then attached to the supporting frame of a rotating deposition system, and such heat sinks can be integrated into such intermediate packages or baseplates. Such heat sinks can comprise thermally conductive material that can maintain a substantially constant temperature. The temperature control mechanism can be active (e.g., water cooling) or passive (e.g., radiation and/or conduction).

FIG. 5B is the planar representation of the outer surface of rotating drum 510 of FIG. 5A. FIG. 5B shows micro-patterned regions 512 which appear as lines on the surface 510. Each line can be micro-machined on surface 510 to create the desired surface structure. Depending on the desired application, each line (i.e., the micro-patterned regions) may comprise identical or different layouts. The pattern of micro-pattered features on the drum can correspond to the pattern of film material to be deposited onto the deposition surface. Liquid ink can be delivered by the film material delivery mechanism in a spatially defined pattern or uniformly over a region of the drum.

In one exemplary embodiment, a spatially defined liquid ink delivery pattern can be defined with respect to the micro-patterned structure, such that a liquid ink is delivered onto the transfer surface and the micro-patterned structure assists in further organizing the film material into a prescribed pattern. Depending on the micro-pattern type and the ink properties, the ink may be delivered onto sections of the transfer surface containing only certain types of micro-patterning and not onto sections of the transfer surface containing other types of micro-patterning. Further, the ink may be delivered onto sections of the transfer surface having no micro-patterning or solely onto sections having micro-patterning, again depending on the micro-pattern type and the ink properties. The micro-patterned structures may have the property of drawing the ink into the micro-patterned region from the surrounding area, such that when distributing ink in regions outside of the micropore region, it can be drawn into the micropore region. Alternatively, the micro-patterned structures may have the property of repelling the ink from the micro-patterned region, or blocking the flow of ink across the micro-patterned region, such that when distributing ink in regions having no micro-patterning, it can be contained within such regions and stray ink delivered into the micro-patterned regions can be repelled into those regions having no micro-patterning.

It is also possible that ink delivered to the drum surface is not drawn into the proper regions by the micro-patterned surface and it can be desirable to remove such so-called stray ink prior to transferring the film material onto the substrate. This can be accomplished by utilizing a surface structure that can absorb the ink and a doctor blade (a mechanical blade drawn across the drum surface) to remove the ink not absorbed into the surface structure off the transfer surface and into a collection unit. An air blade can also be used in the same way to remove stray or excess ink. An air blade is a pressurized, localized region of inert gas that is swept over the surface to move the stray ink off the surface.

FIG. 5C is an exploded view of a region of the rotating drum surface of FIG. 5B. In FIG. 5C, the micro-patterned region 520 comprises micropores 522 arranged in rows and columns. The exemplary embodiment of FIG. 5C shows the micropores organized into three columns each having a repeating vertical pattern of micropore pairs. As discussed, micropores 522 can be micro-machined into the surface of the rotating drum 510 to provide the transfer surface of the drum. In another embodiment, the micro-patterned regions are formed as separate transfer surface units and are then attached or adhered either directly to or through intermediate baseplates and/or packages to an underlying rotating or conveying mechanism.

In another exemplary embodiment, the micro-patterned structure on the transfer surface defines a pattern that does not correspond to the pattern of material to be deposited on the surface. Here, the film material is delivered to the drum surface with a spatially defined pattern and the micro-patterned structure on the transfer surface serves primarily to maintain this delivered pattern. The spatially defined pattern of delivered film material, once delivered to the micro-pattered region, may correspond to the pattern of features to be deposited on the deposition surface. In this embodiment, the film delivery mechanism performs the patterning function. In an exemplary embodiment of this configuration, the metered film material comprises a liquid ink and the micro-patterned structure comprises a continuous microporous region over the entire transfer surface area to be inked, and the liquid ink is delivered to the microporous surface in a pattern such that the ink is absorbed by the microporous surface and held in substantially the same pattern, even following optional conditioning steps to remove the carrier fluid. In general, the film delivery mechanism and the micro-patterned structure of the transfer surface can together organize the film material on the transfer surface into a prescribed pattern as required to deliver the desired pattern of film material deposition on the substrate.

The micro-patterned transfer surface may include regions of micropores or microchannels having pore or channel features that extend from the outside surface of the transfer surface unit through to the inside surface of the transfer surface unit, and such transfer surface units may be mounted onto a rotating deposition system such that the inside surfaces of the transfer surface units are substantially uncovered. The micro-patterned region may be thinner than the surrounding material, such that the surrounding material provides a mechanical support for the thinner micro-patterned regions.

The film material delivery mechanism may be located substantially within the rotating deposition system and deliver the film material onto the inside surface of the transfer surface units mounted onto the rotating deposition system, so that the film material is delivered onto the inside surface of the thin micro-patterned regions suspended between supporting material, and upon subsequently conditioning the film material and energizing the transfer surface, at least a portion of the film material is delivered from the transfer surface to the deposition surface where it is deposited as a substantially solid film on a substrate. In this embodiment, the film material delivery may include an inkjet print head located within the drum.

The micro-patterned region of the exemplary transfer surfaces may comprise regions of material having structures that extend a depth into the transfer surface, but not through the transfer surface unit. Such micro-patterned structures are only open on the front or outside surface, in contrast to the micro-patterned structures described in the prior paragraph that are open to both the back or inside surface and the front or outside surface of the transfer surface unit. The film material can be metered to such a transfer surface by delivering film material onto the front or outside surface and upon subsequently energizing the transfer surface, the film material is delivered from the transfer surface onto the deposition surface where it is deposited as a substantially solid film. This configuration can be advantageous in that all of the film material delivered onto the transfer surface upon energizing the transfer surface is directed toward the deposition surface. In contrast, in a configuration utilizing micro-patterned structures that extend from outside to the inside surface, some of the film material may leak or be directed out through the inside surface of the transfer surface (and thereby away from the deposition surface) and such film material will be wasted and potentially provide a source of debris or contamination within the rotating deposition system.

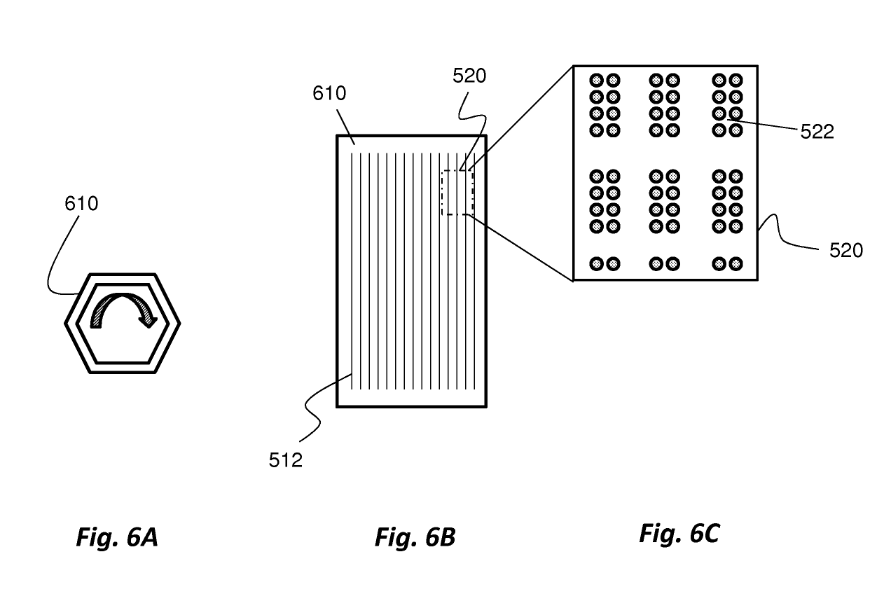

FIG. 6A shows an exemplary rotating, facetted component of a deposition system according to an embodiment of the disclosure. In the exemplary embodiment of FIG. 6A, a hexagonal facetted drum (or conveyor-type) deposition system 610 is used to deposit film material on a substrate. FIG. 6B is surface representation of a transfer surface on one of the facets of the deposition system of FIG. 6A. More specifically, FIG. 6B is the planar representation of the outer surface of one of the facets of rotating facetted drum 610. FIG. 6C is an exploded view of a region of the rotating facetted drum of FIG. 6B. All other peripheral parts are similar to those of FIG. 5 and are similarly numbered.

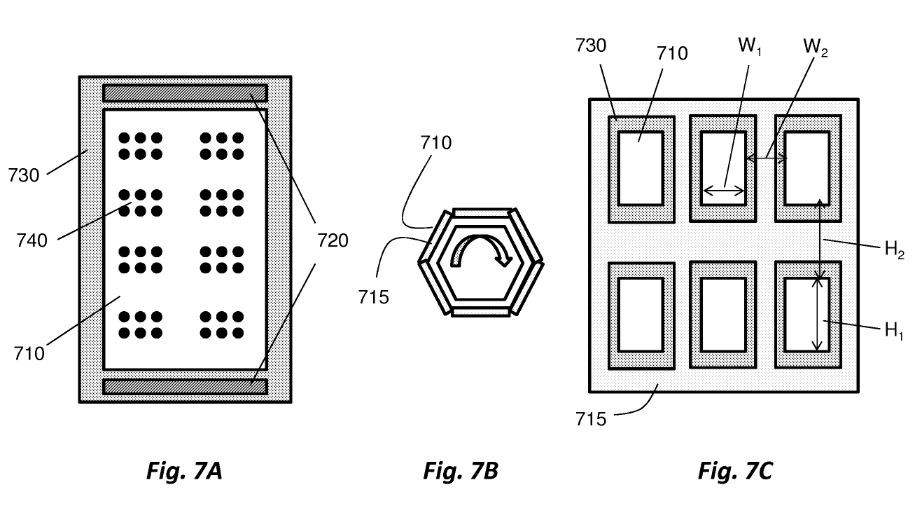

FIG. 7A shows an exemplary transfer surface unit having an activating unit and a micro-patterned region according to one embodiment of the disclosure. The transfer surface unit of FIG. 7A, includes transfer surface 710, activating elements 720 (which may be integrated with the unit), support structure 730 and micro-patterned surface structures 740. Activating elements 720 can comprise heating elements, for example, resistive heating elements that can be used to heat the transfer surface to condition the film material for transfer and/or to transfer the film material onto the substrate. Activating elements 720 may also comprise piezoelectric element(s) that can be used for transferring the film material onto the substrate.

FIG. 7B shows an exemplary hexagonal rotating drum deposition system according to an embodiment of the disclosure. Specifically, FIG. 7B shows a rotating, facetted component of a deposition system having baseplates on each of the facets for mounting together one or more discrete, substantially co-planar transfer surfaces in the form of transfer surface units, according to an embodiment of the disclosure. Each face of the hexagonal drum has a facet surface baseplate 715 for mounting one or more transfer surface units. Each baseplate 715 can be coupled to a respective facet.

FIG. 7C shows an exemplary baseplate 715 having six transfer surface units mounted together in a co-planar surface. The transfer surface units can be identical or different. Each transfer surface unit may include the elements described in FIG. 7A. In addition, dimensions W₁ and H₁ define respectively the width and height of the transfer surface on each of the substantially identical transfer surface units. Dimensions W₂ and H₂ define, respectively, the width and height separation distances between the transfer surfaces as a result of the mounting of the transfer surface units on the baseplate 715. In one embodiment, W₁ is equal to W₂ and H₁ is equal to H₂. In another embodiment, W₂ is equal to an integer multiple of W₁ other than one. In yet another embodiment, H₂ is equal to an integer multiple of H₁ other than one.

FIGS. 7A-7C cumulatively show the integration of multiple baseplates onto a multiple transfer surfaces. In one embodiment, an integrated system was formed where each facet (or transfer surface) supported twelve discrete transfer surfaces on a faceted drum having six facets.

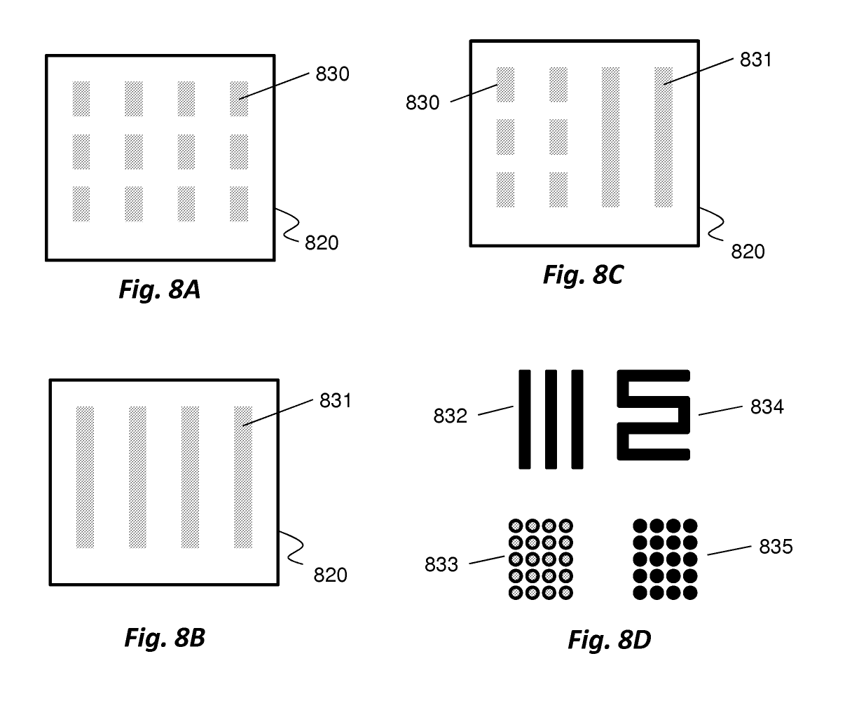

FIGS. 8A-8D show exemplary micro-patterned surfaces according to one embodiment of the disclosure. As discussed, the micro-patterned surfaces structures can be formed on a transfer surface. The micro-patterned surfaces serve different utilities. For example, micro-patterned surfaces can be used to form a film of desired shape and texture. The micro-patterned surfaces can also be used to control film thickness, flow of film material on the transfer surface and surface configuration.

In FIG. 8A, transfer surface region 820 contains a grid of rectangular regions 830 containing micro-patterned structures. In FIG. 8B, transfer surface region 820 contains a series of lines 831 containing micro-patterned structures. In FIG. 8C, transfer surface region 820 contains a combination of rectangular micro-patterned regions 830 and line shaped micro-patterned regions 831. FIG. 8D shows examples of individual micro-pattern features defining discrete rectangular regions that can be used in a pattern alone or in combination to fill a larger micro-patterned region, such as region of the type 830 and 831. Namely, micro-patterned feature 832 comprises a sequence of discrete linear micro-channels, micro-patterned feature 833 comprises an array of micro-pillars, micro-patterned feature 834 comprises a continuous snake micro-channel, and microchannel feature 835 comprises an array of micro-pores.

There are many different ways to meter out and deliver the film material to the transfer surface that can be applied to methods and apparatuses described above. Some of these methods have been described above. For example, in the case the material is delivered in the form of a liquid ink, the liquid ink can be delivered using inkjet printing techniques. Other exemplary liquid ink delivery mechanisms include nozzle jet printing, gravure printing, slot or slit coating, spray coating, and wet stamping. In the case the material is delivered in the form of a gaseous vapor ink, gas vapor can be delivered using a thermal evaporation process. Other exemplary gas vapor delivery mechanisms may include physical or chemical vapor deposition systems, including electron beam evaporation, sputtering, atomic layer deposition, molecular beam epitaxy and molecular organic chemical vapor deposition. Gas vapor delivery can be performed at ambient pressures, reduced pressures, or elevated pressures. In the case the film material is delivered in the form of a solid ink, the solid ink can be delivered using contact pressure transfer, in which solid ink material coated onto an intermediate sheet that is brought into contact with the transfer surface, pressure applied to the intermediate sheet, and the intermediate sheet then removed, such that where the pressure was applied the solid ink material transfers onto the transfer surface and remains after the intermediate sheet is removed. Other exemplary solid phase delivery mechanisms include contact laser transfer (similar to contact pressure transfer, but where laser energy is used to effect transfer instead of pressure), contact thermal transfer (similar to contact pressure transfer, but where thermal energy is used to effect transfer instead of pressure), and solid particle spray coating, in which a stream of solid ink particles is directed onto the transfer surface such that at least a portion of the solid ink particles stick to the transfer surface.

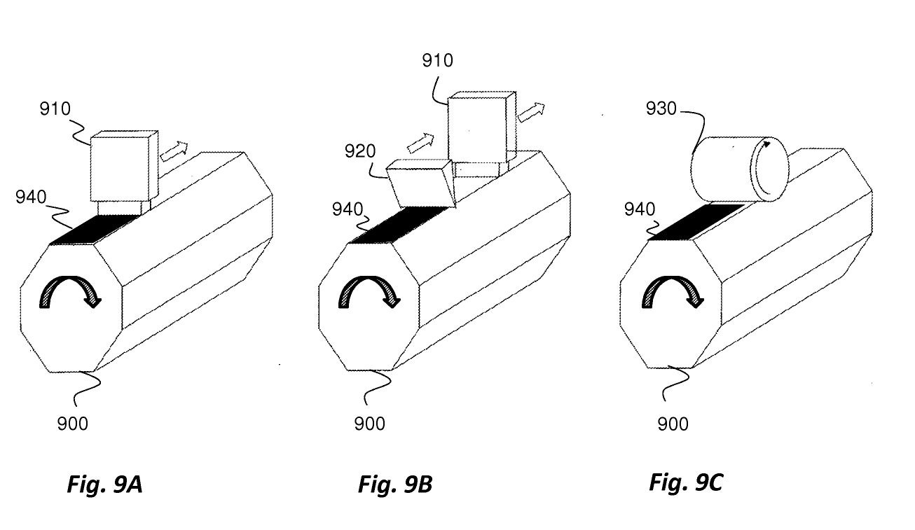

FIGS. 9A-9C illustrate three exemplary wet coating techniques for depositing film material on a transfer surface. FIG. 9A shows a slit coating technique for delivering film material 940, which can be liquid ink, onto a facetted surface of drum 900. Slit coating unit 910 moves across one of the drum facets from one end of the facet to other to deliver liquid ink coating 940. FIG. 9B shows another exemplary embodiment in which a slit coating technique with a doctor blade is used for ink delivery onto a facet of facetted drum 900. Here, slit coating unit 910 moves across one of the drum facets in a continuous manner from one end of the facet, and doctor blade 920 follows slit coating unit 910 across the facet surface to remove excess ink. An air knife (not shown) may also be utilized instead of, or in addition to, doctor blade 920 for the same purpose.

FIG. 9C shows another embodiment in which roller unit 930 is used to deliver film material to a facet of facetted drum 900 liquid ink coating 940. Here, ink is delivered onto the surface of the roller in roller unit 930 and then roller 930 delivers ink by wetting the ink from the surface of the roller to the surface of the drum facet and rolling across the facet. A roller can provide liquid ink to the facet surface in a pattern and thereby provide a patterned ink delivery mechanism. An example of a pattern-capable roller is a gravure drum. In another exemplary embodiment (not shown), a gravure plate is used for ink delivery. The gravure plate is first coated with ink, the plate delivers ink by wetting the ink on the surface of the plate to the surface of the drum facet. In all of these embodiments, the rotating transfer surface assembly (e.g., the drum or facetted drum) and the ink delivery mechanism can be stationary or mobile with respect to each other. The relative movement (either through transfer surface assembly rotation, ink delivery mechanism motion or both) can be utilized to improve the spatial control of ink delivery.

While the principles of the disclosure have been illustrated in relation to the exemplary embodiments shown herein, the principles of the disclosure are not limited thereto and include any modification, variation or permutation thereof.

What is claimed is:

1. An apparatus for transferring a film material to a substrate, the apparatus comprising:
a transfer surface having a plurality of micro-patterned structures thereon for organizing a quantity of film material;
a delivery mechanism for supplying the quantity of film material to the transfer surface; and
an axis about which the transfer surface can receive the quantity of film material from the delivery mechanism and rotate prior to dispensing at least a portion of the quantity of film material.

2. The apparatus of claim 1, further comprising a conditioning unit for conditioning the film material received by the transfer surface.

3. The apparatus of claim 1, further comprising an energy source for transferring the film material from transfer surface onto a substrate.

4. The apparatus of claim 1, wherein the film material is transferred from the transfer surface by thermally evaporating the film material.

5. The apparatus of claim 1, wherein the transfer surface comprises at least a portion of the outer surface of a drum or a facetted drum.

6. The apparatus of claim 1, wherein the plurality of micro-patterned structures are continuous over the entire transfer surface.

7. The apparatus of claim 1, wherein each of the plurality of the micro-patterned structure defines a discrete region of the transfer surface.

8. The apparatus of claim 1, wherein the micro-patterned structures are selected from the group consisting of micropores, micro-pillars, micro-channels and micro-arrays.

9. The apparatus of claim 1, wherein the micro-patterned structures organize the received film material in a first arrangement enabling the transfer surface to transfer the film material onto the substrate in substantially the first arrangement.

10. The apparatus of claim 1, wherein the micro-patterned structures organize the received film material in a first arrangement enabling the transfer surface to transfer the film material onto the substrate in a second arrangement.

11. The apparatus of claim 1, wherein the film material is delivered to the transfer surface in the form of a liquid ink, a solid ink and a gaseous vapor ink.

12. The apparatus of claim 11, wherein the liquid ink further comprises a carrier fluid with dissolved or suspended film material.

13. The apparatus of claim 12, further comprising a conditioning unit for substantially evaporating a carrier fluid from the liquid ink on the transfer surface.

14. The apparatus of claim 11, wherein the liquid ink further comprises a melted ink material.

15. The apparatus of claim 1, wherein the film material deposits onto the transfer surface in one of a substantially liquid phase or a substantially solid phase.

16. The apparatus of claim 1, wherein the delivery mechanism is selected from the group consisting of inkjet, slot coater, doctor blade, air knife, wet stamp and gravure.

17. The apparatus of claim 1, further comprising a first transfer surface and a second transfer surface, wherein the first transfer surface includes a first micro-patterned structure and the second transfer surface includes a second micro-patterned structure.

18. The apparatus of claim 1, further comprising a cleaning source for cleaning the transfer surface after the film material is dispensed.

19. A non-contact film deposition apparatus, comprising:
a delivery mechanism for supplying a quantity of film material;
a transfer surface for receiving the quantity of film material from the delivery mechanism and transferring at least a portion of the quantity of the film material in a second pattern onto a substrate without materially contacting the substrate; and
a micro-patterned structure on the transfer surface, the micro-patterned structure organizing the received film material in a first pattern.

20. The apparatus of claim 19, wherein the first pattern and the second pattern are substantially identical.

21. The apparatus of claim 19, wherein the transfer surface receives the quantity of film material at a first plane and transfers the film material on the substrate at a second plane.

22. The apparatus of claim 19, wherein the film material is transferred from the transfer surface by thermally evaporating the film material.

23. The apparatus of claim 19, wherein the film material deposits onto the substrate in substantially the solid phase.

24. The apparatus of claim 19, wherein the transfer surface receives in a first plane a quantity of film material and transfers at least a portion of the quantity of film material to the substrate in a second plane.

25. The apparatus of claim 24, wherein the first plane and the second plane are orthogonal or parallel to each other.

26. The apparatus of claim 19, further comprising a conditioning unit for conditioning the film material received by the transfer surface.

27. The apparatus of claim 19, wherein the micro-patterned structure is selected from the group consisting of micropores, micro-pillars, micro-channels and micro-arrays.

28. The apparatus of claim 19, wherein the transfer surface comprises at least a portion of the outer surface of a drum or a facetted drum.

29. The apparatus of claim 19, wherein the delivery mechanism is selected from the group consisting of inkjet, slot coater, doctor blade, air knife, wet stamp and gravure.

30. The apparatus of claim 19, wherein the film material is delivered to the transfer surface in the form of a liquid ink, a solid ink or a gaseous vapor ink.

31. The apparatus of claim 30, wherein the liquid ink further comprises a carrier fluid with dissolved or suspended film material.

32. The apparatus of claim 31, further comprising a conditioning unit for substantially evaporating a carrier fluid from the liquid ink on the transfer surface.

33. The apparatus of claim 19, wherein the film material contains OLED material.

34. A film deposition apparatus, comprising:
a delivery mechanism for supplying a quantity of liquid ink having dissolved or suspended film material in a carrier fluid;
a first transfer surface for receiving the quantity of liquid ink from the delivery mechanism in a first plane and delivering a film material substantially free of the carrier fluid in a second plane;
an energy source for transferring at least a portion of the film material from the first transfer surface onto a substrate; and
an activating source for moving the first transfer surface between the first plane and the second plane.

35. The apparatus of claim 34, further comprising a conditioning unit for removing the carrier fluid from the first transfer surface to form a film material substantially free of carrier fluid.

36. The apparatus of claim 34, wherein the delivery mechanism is selected from the group consisting of inkjet, slot coater, doctor blade, air knife, wet stamp and gravure.

37. The apparatus of claim 34, wherein the film material is transferred from the first transfer surface by thermally evaporating the film material.

38. The apparatus of claim 34, wherein the first transfer surface further comprises a first region and a second region, the first and the second regions respectively receiving a first quantity of liquid ink and a second quantity of liquid ink from the delivery mechanism.

39. The apparatus of claim 38, wherein the first region and the second region receive the first and the second quantity of ink substantially simultaneously.

40. The apparatus of claim 38, wherein the first region and the second region receive the first and the second quantity of ink sequentially.

41. The apparatus of claim 38, wherein the first region and the second region are on different planar surfaces.

42. The apparatus of claim 38, wherein the first region and the second region receive the first and second quantity of ink in different orientations.

43. The apparatus of claim 34, wherein the step of transferring the film material from the first transfer surface onto the substrate occurs without the transfer surface materially contacting the substrate.

44. The apparatus of claim 43, wherein the activating source comprises an energy source for transferring film material from the first transfer surface to the substrate.

45. The apparatus of claim 43, wherein the activating source comprises a thermal energy source or a piezoelectric energy source.

46. The apparatus of claim 34, wherein the first transfer surface organizes the quantity of liquid ink received from the delivery mechanism at a first orientation and transfers the film material substantially free of the carrier fluid to the substrate in a second orientation.

47. The apparatus of claim 34, further comprising a second transfer surface, the first and the second transfer surfaces respectively receiving a first quantity of liquid ink and a second quantity of liquid ink from the delivery mechanism.

48. The apparatus of claim 47, wherein the first transfer surface and the second transfer surface receive the first and the second quantity of ink substantially simultaneously.

49. The apparatus of claim 47, wherein the first transfer surface and the second transfer surface receive the first and the second quantity of ink sequentially.

50. The apparatus of claim 47, wherein the first transfer surface and the second transfer surface are on different planar surfaces.

51. The apparatus of claim 47, wherein the first transfer surface and the second transfer surface receive the first and second quantity of ink in different orientations.

52. A system for depositing a film on a substrate, the system comprising:
a delivery mechanism for supplying a quantity of film material;
a first transfer surface adapted to receive a quantity of film material and transfer at least a portion of the quantity of film material onto the substrate such that the film material deposits on the substrate as a substantially solid film;
a rotational mechanism for moving the first transfer surface between different planes about an axis; and
a memory circuit in communication with a controller circuit, the memory circuit comprising instructions directing the controller circuit to:
position the first transfer surface in a first plane to receive a first quantity of film material from the delivery mechanism,
provide the first quantity of film material to the first transfer surface in the plane in a first pattern,
position the first transfer surface in a second plane proximal to the substrate to transfer at least a portion of the first quantity of film material onto the substrate,
activate the first transfer surface in the second plane to transfer at least a portion of the first quantity of film material onto the substrate such that the film material deposits as a substantially solid film on the substrate in a second pattern.

53. The system of claim 52, wherein the first pattern and the second pattern are substantially similar.

54. The system of claim 52, wherein the memory circuit further comprises instructions to position the second transfer surface to receive a second quantity of film material from the delivery mechanism while the first transfer surface is positioned proximal to but not materially contacting the substrate to transfer at least a portion of the first quantity of film material onto the substrate.

55. The system of claim 54, wherein the memory circuit further comprises instructions to provide the second quantity of film material to the second region while the first region transfers at least a portion of the first quantity of film material onto the substrate.

56. The system of claim 52, wherein the quantity of film material delivered to the first transfer surface comprises a liquid ink having dissolved or suspended film material in a carrier fluid.

57. The system of claim 56, further comprising a conditioning system for removing the carrier fluid from the first quantity of liquid ink received by the first transfer surface to provide a film material substantially free of the carrier fluid in a second plane.

58. The system of claim 52, further comprising an energy source for transferring at least a portion of the film material from the first transfer surface onto the substrate without materially contacting the substrate.

59. The system of claim 52, wherein at least a portion of the first transfer surface includes regions having a micro-patterned structure selected from the group consisting of micropores, micro-pillars, micro-channels and micro-arrays.

60. The system of claim 52, wherein the film material contains OLED material.

61. The system of claim 52, wherein the film material is transferred from the first transfer surface onto the substrate by thermally evaporating the film material.

62. A method for printing a substantially solid film on a substrate, comprising:
providing a first transfer surface;
delivering a quantity of film material to the first transfer surface at a first plane, the first transfer surface having a plurality of micro-patterned structures thereon;
organizing the quantity of film material on the first transfer surface through the plurality of micro-patterned structures;
rotating the first transfer surface about an axis to position the first transfer surface at a second plane; and
transferring at least a portion of the quantity of film material from the first transfer surface onto a substrate in the second plane such that the film material deposits on the substrate in substantially the solid phase.

63. The method of claim 62, wherein the film material is transferred from the first transfer surface by thermally evaporating the film material.

64. The method of claim 62, further comprising conditioning the film material received on the first transfer surface prior to transferring the film material from the first transfer surface onto the substrate.

65. The method of claim 62, wherein the step of delivering a quantity of film material to the first transfer surface further comprises delivering a quantity liquid ink comprising dissolved or suspended film material in a carrier fluid.

66. The method of claim 65, further comprising removing the carrier fluid from the quantity of liquid ink prior to transferring the film material from the first transfer surface onto the substrate to provide a film material substantially free of the carrier fluid.

67. The method of claim 62, further comprising organizing the film material on the first transfer surface in a first pattern, and forming a substantially solid film on the substrate in a second pattern.

68. The method of claim 67, wherein the first pattern and the second pattern are substantially different.

69. The method of claim 67, wherein the first pattern and the second pattern are substantially similar.

70. The method of claim 67, wherein the first pattern reflects the micro-patterned structure on the transfer surface.

71. The method of claim 62, further comprising energizing the first transfer surface to dispense the film material.

72. The method of claim 71, wherein energizing the first transfer surface comprises heating or agitating at least a portion of the film material on the first transfer surface.

73. The method of claim 62, further comprising conditioning the film material on the first transfer surface before transferring the quantity of film material to the substrate.

74. The method of claim 62, wherein the step of delivering the quantity of film material to the transfer surface further comprises providing one of an inkjet, slot coater, a doctor blade, an air knife, wet stamping and a gravure mechanism to deliver the film material.

75. The method of claim 62, further comprising providing a second transfer surface, delivering a first quantity of film material on the first transfer surface and a second quantity of film material on the second transfer surface simultaneously or sequentially, and transferring at least a portion of the first and second quantities of film material onto the substrate simultaneously or sequentially.

76. The method of claim 62, further comprising providing a first and second region on the transfer surface, delivering a first quantity of film material on the first region and a second quantity of film material on the second region simultaneously or sequentially, and transferring at least a portion of the first and second quantities of film material from the first and the second regions onto the substrate simultaneously or sequentially.

77. A method for printing a substantially solid film on a substrate, comprising:
providing a first quantity of a liquid ink having dissolved or suspended film material in a carrier fluid and a second quantity of a liquid ink having dissolved or suspended film material in a carrier fluid;
supplying the first quantity of liquid ink to a first region on a transfer surface in a first plane;
removing the carrier fluid from the first quantity of ink to form a first quantity of film material substantially free of the carrier fluid;
supplying the second quantity of liquid ink to a second region on a transfer surface in a second plane;
transferring at least a portion of the first quantity of film material from the first region onto a substrate in a third plane;
removing the carrier fluid from the second quantity of film material to form a second quantity of film material substantially free from the carrier fluid;
transferring at least a portion of the second quantity of film material from the second region onto a substrate in a fourth plane; and
receiving the transferred film material on the substrate such that the film material deposits substantially free from the carrier fluid.

78. The method of claim 77, wherein the first and the second planes are substantially the same.

79. The method of claim 77, wherein the film material contains OLED material.

80. The method of claim 77, wherein the third and the fourth planes are substantially the same.

81. The method of claim 77, further comprising moving the transfer surface regions between the first, second, third and fourth planes.

82. The method of claim 77, wherein the first transfer region is positioned in the first plane at substantially the same time as the second transfer region is positioned in the fourth plane.

83. The method of claim 77, wherein the first transfer region is positioned in the third plane at the substantially the same time as the second transfer region is positioned in the second plane.

84. The method of claim 77, wherein the first and second transfer regions are located on different transfer surfaces.

85. The method of claim 77, wherein the film material is transferred from the transfer surface by thermally evaporating the film material.

86. The method of claim 77, further comprising transferring at least a portion of the first quantity of film material from the first transfer surface onto the substrate without materially contacting the transfer surface with the substrate.

87. The method of claim 77, further comprising supplying the second quantity of film material to the second region while transferring at least a portion of the first quantity of film material from the first region onto the substrate.

88. The method of claim 77, further comprising supplying the second quantity of film material to the second region while drying the first quantity of film material on the first region.

89. The method of claim 77, further comprising providing a micro-patterned surface on the first region and organizing the first quantity of film material on the micro-patterned surface.

90. The method of claim 77, further comprising energizing the second region to transfer at least a portion of the second quantity of film material onto the substrate

91. The method of claim 77, further comprising cleaning the first region after transferring at least a portion of the first quantity of film material onto the substrate.

92. A non-contact method for film deposition, comprising:
providing a transfer surface having a quantity of film material thereon;
moving the transfer surface to a position to transfer the quantity of film material onto a substrate; and
transferring at least a portion of the first quantity of film material from the first transfer surface onto the substrate without materially contacting the transfer surface with the substrate;
wherein the film material on the transfer surface is substantially solid for at least a portion of the time following delivery of the film material onto the transfer surface and prior to transferring onto the substrate.

93. The method of claim 92, wherein the film material contains OLED material.

94. The method of claim 92, wherein the film material deposits on the substrate in substantially the solid phase.

95. The method of claim 92, wherein the film material is transferred from the transfer surface by thermally evaporating the film material.

96. The method of claim 92, wherein the transfer surface receives the quantity of film material at a first plane and transfers the film material onto the substrate at a second plane.

97. The method of claim 96, wherein the first plane and the second plane are orthogonal or parallel to each other.

98. The method of claim 92, further comprising conditioning the film material on the transfer surface.

99. The method of claim 92, further comprising providing a micro-patterned structure on the transfer surface, the micro-patterned structure organizing the film material into a first pattern on the transfer surface prior to transferring the film material onto the substrate.

100. The method of claim 99, wherein the micro-patterned structure is selected from the group consisting of micropores, micro-pillars, micro-channels and micro-arrays.

101. The method of claim 92, wherein the film material deposits on the substrate in a second pattern that is substantially the same as the first pattern.

102. The method of claim 92, wherein the transfer surface comprises at least a portion of the outer surface of a drum or faceted drum.

103. The method of claim 92, wherein the film material deposits onto the transfer surface in one of a substantially liquid phase or a substantially solid phase.
